(19) United States
(12) Patent Application Publication
(10) Pub. No.: US 2010/0165852 A1
(43) Pub. Date: Jul. 1, 2010

(54) NODE APPARATUS AND METHOD FOR PERFORMING A LOOPBACK-TEST ON A COMMUNICATION PATH IN A NETWORK

(75) Inventors: Shinichi Kozuka, Kawasaki (JP); Toshifumi Amano, Kawasaki (JP); Kazuhiko Hata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/636,974

(22) Filed: Dec. 14, 2009

(30) Foreign Application Priority Data
Dec. 25, 2008 (JP) 2008-331486

(51) Int. Cl. H04L 12/26

(52) U.S. Cl. 370/249

(57) ABSTRACT

A communication path is set from an ingress node to an egress node on the basis of a specified path setting protocol, and a loopback-test signal is transmitted to the egress node through the communication path so as to perform a loopback-test on the egress node. The ingress node receives a loopback-test response signal transmitted from the egress node on which the loopback-test has been performed, and determines whether or not a loopback-test on the egress node has ended normally by analyzing the received loopback-test response signal.

### CROSS-REFERENCE TO RELATED APPLICATION

This application is based upon and claims the benefit of priority of the prior Japanese Patent Application No. 2008-331486, filed on Dec. 25, 2008, the entire contents of which are incorporated herein by reference.

### FIELD

The present invention relates to node apparatus and method for performing a loopback-test on a communication path in a network.

### BACKGROUND

According to GMPLS (Generalized Multi-Protocol Label Switching), which is a path setting protocol, a node exchanges information on the node with the neighboring nodes by advertising the information. Thus, the node can recognize information on the neighboring nodes, such as information on nodes connected with the neighboring nodes and the bandwidth used for connection with the nodes.

When the instruction to establish a path is notified, by an external device, to the ingress node which is to be the starting point of the communication path according to GMPLS, each of relevant nodes autonomously calculates paths, determines a path to be used, and establishes a communication path from the ingress node to the end node thereof.

FIG. 15 is a schematic diagram illustrating an example of a communication path according to GMPLS. According to a communication system based on GMPLS, as depicted in FIG. 15, a communication path is established from an ingress node in which a signal comes, through a relay node that relays the signal, to an egress node of which the signal goes out. Therefore, the ingress node issues a path setting instruction based on GMPLS to the relay nodes and the egress node. Thus, nodes to be included in the communication path are selected from a group of nodes available for relay nodes, thereby establishing the communication path from the ingress node to the egress node.

FIG. 16 is a diagram illustrating an example of a procedure for setting a communication path according to GMPLS. As depicted in FIG. 16, upon receiving from an external device an instruction to start “path setting”, an ingress node A performs “setting of alarm inhibition” and then transmits “Path MSG” to a relay node B.

Then, the relay node B transmits “Path MSG” to an egress node C after “setting of alarm inhibition”. The egress node C, after “setting of alarm inhibition”, performs “setting of cross-connect” and transmits “Resv MSG” to the relay node B.

The relay node B transmits “Resv MSG” to the ingress node A after the “setting of cross-connect”. The ingress node A performs the “setting of cross-connect”, thereby completing the setting of the communication path between the ingress node A and the egress node C. After that, each node cancels the inhibited alarm by using the “Path MSG” and “Resv MSG”, in a manner similar to the case of path setting.

Japanese Laid-open Patent Publication Nos. 10-190606 and 6-216872 disclose technology in which a test is performed by creating a path test signal and inserting the created path test signal into a payload. More specifically, a managing apparatus that manages paths creates a path test signal, and performs a test on a path by transmitting the created path test signal to the path to be tested.

According to the GMPLS protocol, nodes in a network autonomously establish a communication path. However, there is a problem that the normal and proper communication of a signal, such as data contained in a payload, is not guaranteed on the established path. Therefore, when signal communication fails, the identification of the part having a failure requires complicated operations such as collection of information on the relevant nodes, re-establishment of a path, and check of the signal communication.

According to the technology in which a managing apparatus transmits a path test signal, the managing apparatus needs to recognize a communication path to be tested from the ingress node to the egress node, in order to perform a test on the communication path. However, in GMPLS, since nodes autonomously establish paths, an external device such as the managing apparatus may not recognize the established paths. Thus, it is difficult to transmit a path test signal to the established communication paths and to perform a test on the established communication paths.

### SUMMARY

According to an aspect of an embodiment, there is provided a node apparatus operable to perform a loopback-test on a communication path in a network. A communication path is set from an ingress node to an egress node on the basis of a specified path setting protocol, and a loopback-test signal is transmitted to the egress node through the communication path so as to perform a loopback-test on the egress node. The ingress node receives a loopback-test response signal transmitted from the egress node on which the loopback-test has been performed, and determines whether or not a loopback-test on the egress node has ended normally by analyzing the received loopback-test response signal.

The object and advantages of the invention will be realized and attained by means of the elements and combinations particularly pointed out in the claims.

It is to be understood that both the foregoing general description and following detailed description are exemplary and explanatory and are not restrictive of the invention, as claimed.

### BRIEF DESCRIPTION OF THE DRAWINGS

FIG. 1 is a diagram illustrating an example of a configuration of an ingress node, according to an embodiment;

FIG. 2 is a diagram illustrating an example of a configuration of a SONE' frame;

FIG. 3 is a diagram illustrating an example of a path overhead in a SONET frame;

FIG. 4 is a diagram illustrating an example of a J1-byte area in the path overhead, according to an embodiment;

FIG. 5 is a diagram illustrating an example of a payload area;

FIG. 6 is a diagram illustrating an example of a configuration of a GMLS controller in an ingress node, according to an embodiment;

FIG. 7 is a diagram illustrating an example of a table storing a management information DB, according to an embodiment;

FIG. 8 is a diagram illustrating an example of a configuration of a relay node, according to an embodiment;

FIG. 9 is a diagram illustrating an example of a configuration of an egress node, according to an embodiment;

FIGS. 10A, 10B, and 10C are a diagram illustrating an example of a sequence flow for setting a communication path and performing a loopback-test, according to an embodiment;

FIGS. 11A and 11B are a diagram illustrating an example of a sequence flow of retry loopback test processing, according to an embodiment;

FIG. 12 is a diagram illustrating an example of a sequence flow of retry loopback test processing, according to an embodiment;

FIG. 13 is a diagram illustrating an example of an operational flowchart for transmitting a loopback-test signal executed by an ingress node, according to an embodiment;

FIGS. 14A and 14B are a diagram illustrating an example of an operational flowchart of a node for performing a loopback-test, according to an embodiment;

FIG. 15 is a schematic diagram illustrating an example of a communication path according to GMPLS; and

FIG. 16 is a diagram illustrating an example of a procedure for setting a communication path according to GMPLS.

### DESCRIPTION OF THE PREFERRED EMBODIMENTS

With reference to the attached drawings, embodiments of the present invention will be described in detail below.

### First Embodiment

The configuration of an ingress node, the configuration of a relay node, the configuration of an egress node, processing by the entire system, and a processing flow by the nodes according to a first embodiment will be described in order.

### [Configuration of Ingress Node]

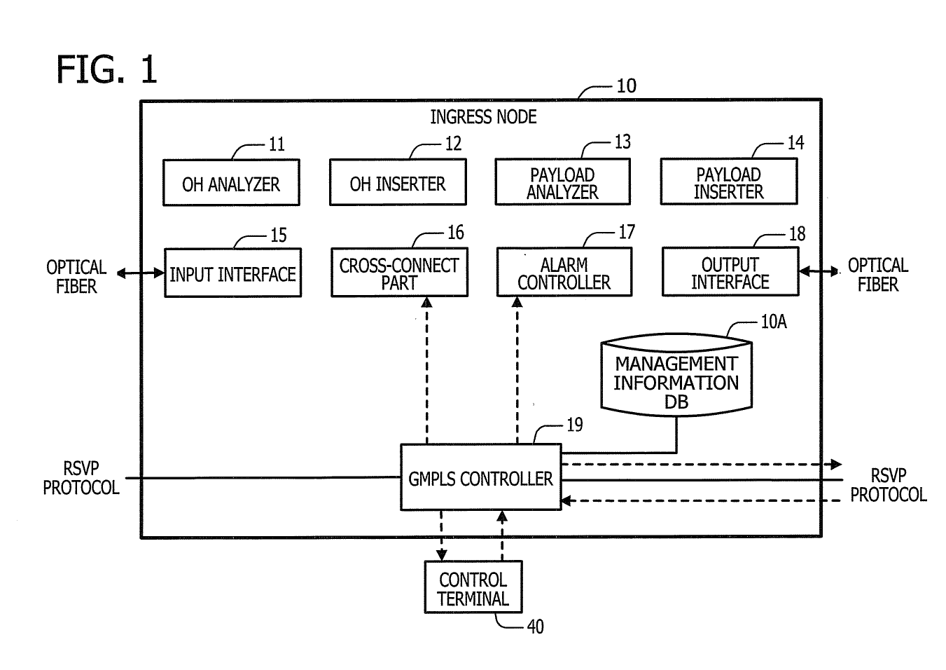

FIG. 1 is a diagram illustrating an example of a configuration of an ingress node, according to an embodiment.

As depicted in FIG. 1, an ingress node 10 includes an OH analyzer 11, an OH inserter 12, a payload analyzer 13, a payload inserter 14, an input interface 15, a cross-connect part 16, an alarm controller 17, an output interface 18, a GMPLS controller 19, and a management information DB 10A. The ingress node 10 is connected to a control terminal 40 via a network and the like. The processing performed by these parts will be described below.

The ingress node 10 performs data transmission and reception through the input interface 15 and output interface 18 via an optical fiber.

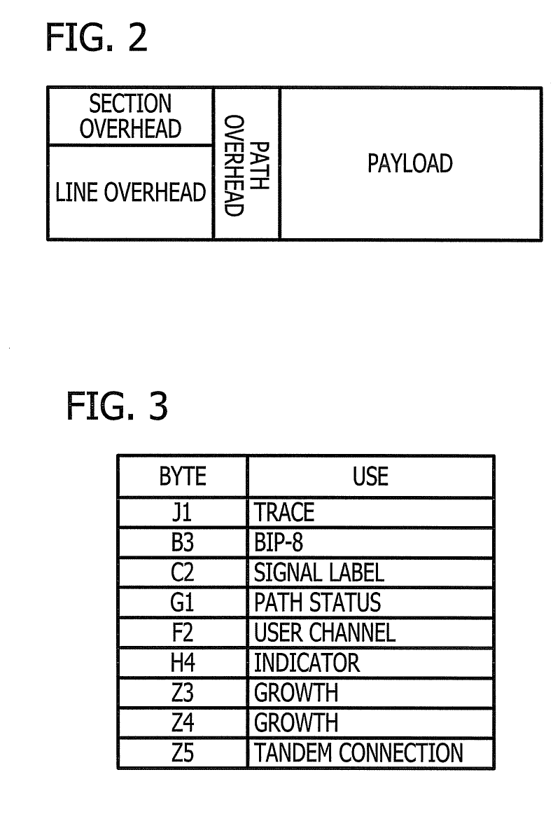

FIG. 2 is a diagram illustrating an example of a configuration of a SONET frame. Now, the configuration of a SONET (Synchronous Optical NETwork) frame, which is to be used by the ingress node 10 for performing an automatic loopback test, will be described. As depicted in FIG. 2, a SONET frame includes a section overhead area, a line overhead area, a path overhead area, and a payload area. According to an embodiment, the path over head area and the payload area are used for performing a loopback-test on a communication path.

FIG. 3 is a diagram illustrating an example of a path overhead area in a SONET frame. As depicted in FIG. 3, the path over head area includes, for example, J1-byte, B3-byte, C2-byte, G1-byte, F2-byte, H4-byte, Z3-byte, Z4-byte, and Z5-byte. According to an embodiment, J1-byte is utilized to perform a loopback-test.

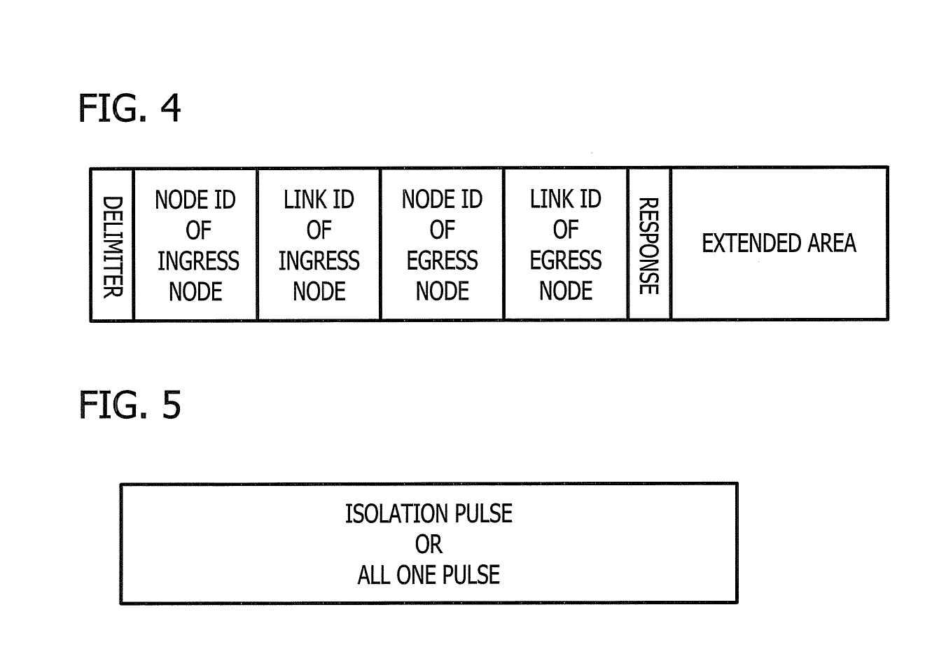

FIG. 4 is a diagram illustrating an example of a J1-byte area in the path overhead, which is used for performing a loopback-test according to an embodiment. The J1-byte area includes a delimiter, a node ID of an ingress node, a link ID of an ingress node, a node ID of an egress node, a link ID of an egress node, response information, and an extended area. The delimiter is a delimiter for the Ji-byte area. The node ID of an ingress node is a node ID according to GMPLS and identifying the ingress node of the communication path. The link ID of an ingress node is a link ID according to GMPLS and identifying a port of the ingress node of the communication path. The node ID of an egress node is a node ID according to GMPLS and identifying the egress node of the communication path. The link ID of an egress node is a link ID according to GMPLS and identifying a port of the egress node of the communication path. The node ID of an ingress node and the node ID of an egress node are used for determining whether or not a test signal received by a node is destined for the node. The response information is used for storing the result of a loopback-test and for determining whether or not a loopback-test has ended normally.

The OH analyzer 11 extracts node information (such as Node ID and Link ID of an ingress node, and Node ID and Link ID of an egress node) and test response information from the J1-byte of the path overhead, and analyzes them. Then, the OH analyzer 11 notifies the GMPLS controller 19 of the analysis result on the J1-byte. The OH analyzer 11 further determines whether or not a loopback-test has ended normally, by referring to the response in the J1-byte of the path overhead returned from the egress node 20.

The OH inserter 12 sets the test signal type to the J1-byte which is configured to be arbitrarily set by a user. More specifically, when the OH inserter 12 receives the instruction to set a test signal by using a J1-byte from the GMPLS control portion 19, the OH inserter 12 sets the test signal type (or Trace) to the J1-byte and inserts the Node ID and Link ID of the ingress node which is the starting point of the established communication path and the Node ID and Link ID of the egress node which is the end point of the communication path, into the J1-byte of the path overhead. (Refer to FIG. 3 and FIG. 4.) Here, the J1-byte is an area into which a user can arbitrarily insert data.

The payload analyzer 13 receives a loopback-test response signal returned from the egress node 30 and analyzes the loopback-test response signal to determine whether or not the loopback-test on the egress node has ended normally. More specifically, the payload analyzer 13 analyzes the payload to determine whether the payload contains the loopback-test signal or not. When the payload contains the loopback-test signal, the payload analyzer 13 determines that the established communication path is a path capable of transmitting a signal.

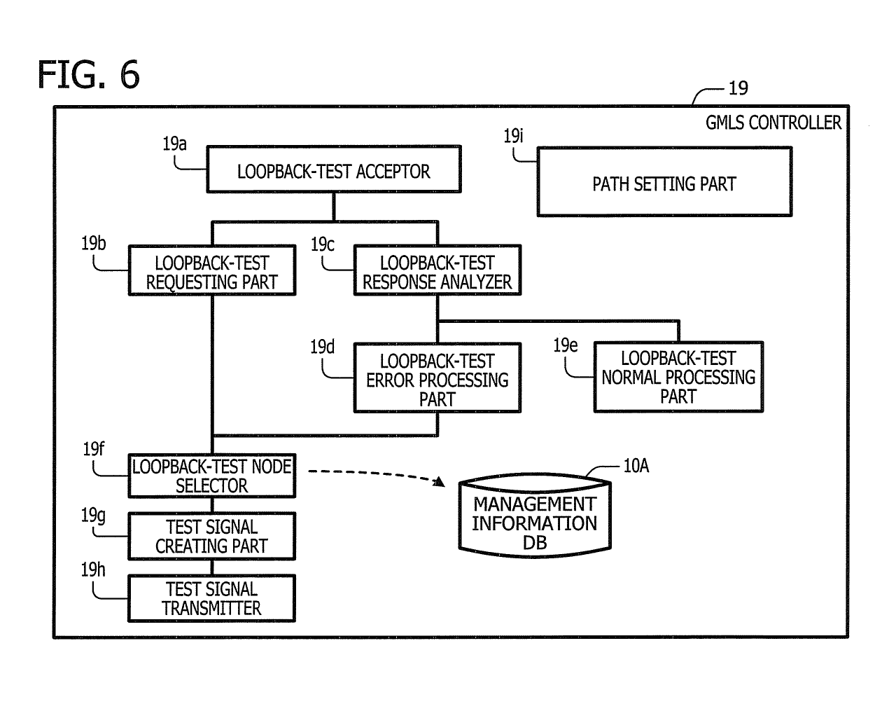

FIG. 5 is a schematic diagram illustrating an example of a payload area, according to an embodiment. As depicted in FIG. 5, either an Isolation pulse or ALL ONE pulse, which is a test area having a specified width, is inserted into the payload area, as data for a loopback-test.

Upon receiving the instruction to set a loopback-test signal from the GMPLS controller 19, the payload inserter 14 creates a payload for a loopback-test by inserting the data for a loopback-test into the payload, and transmits the loopback-test signal to the relay node 20 via the output interface 18.

The input interface 15 receives data via an optical fiber. More specifically, the input interface 15 receives a test signal via an optical fiber. The input interface 15 and output interface 18 are connected to each other through the cross-connect part 16.

The output interface 18 transmits a test signal via an optical fiber. More specifically, after the communication path has been established, the output interface 18 transmits a loopback-test signal to the egress node by designating the established communication path.

Upon receiving the instruction to set cross-connect from the GMPLS controller 19, the cross-connect part 16 connects between the input interface 15 and the output interface 18.

Upon receiving the instruction to inhibit alarms from the GMPLS controller 19, the alarm controller 17 sets the alarm inhibition processing. Upon receiving the instruction to cancel the alarms from the GMPLS controller 19, the alarm controller 17 performs the alarm inhibition cancelling processing.

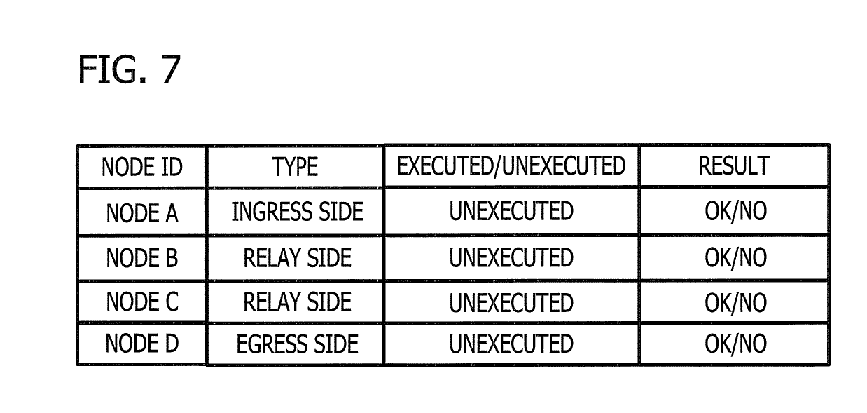

The management information database (DB) 10A stores management information on nodes positioned along the communication path. More specifically, as depicted in FIG. 7, the management information DB 10A stores, in association with a node, a “node number (Node ID)” uniquely given to the node, a “type” indicating the type of the node, “executed/unexecuted” indicating whether or not a loopback-test has been executed on the node, and a “result” indicating the result of the loopback-test executed on the node.

The GMPLS controller 19 sets a communication path on the basis of GMPLS that is an example of a specified path setting protocol. More specifically, upon receiving a path setting request from the control terminal 40, the GMPLS controller 19 performs path calculation and determines relay nodes through which a communication path to be established passes. After that, the GMPLS controller 19 notifies the alarm controller 17 of the instruction to set alarm inhibition. Then, the GMPLS controller 19 transmits “Path MSG” to a relay node 20 on the basis of the RSVP protocol.

After receiving “Resv MSG” from the relay node 20, the GMPLS controller 19 notifies the cross-connect portion 16 of the instruction to set cross-connect. Then, the GMPLS controller 19 transmits a path-setting completion notification to the control terminal 40, thereby completing the path setting process.

After the path setting process has completed, the GMPLS controller 19 notifies the OH inserter 11 of the instruction to set the Node ID and Link ID of the ingress node (which becomes the starting point of the communication path) and the Node ID and Link ID of the egress node (which becomes the end point of the communication path), which are used in the path setting process, to a J1-byte.

The GMPLS controller 19 further notifies the payload inserter 14 of the instruction to set data for a loopback-test to the payload. After that, the GMPLS controller 19 transmits the loopback-test signal to the relay node 20 via the output interface 18.

When receiving the analysis result on the J1-byte from the OH analyzer 31, the GMPLS controller 19 determines whether or not the received test signal is destined to the own node on the basis of the Node ID and Link ID of the ingress node inserted into the J1-byte. When it is determined that the received test signal is destined to the own node, the GMPLS controller 19 further determines whether or not the received test signal is a loopback-test response signal. When it is determined that the received test signal is the loopback-test response signal, the GMPLS control portion 19 determines that the received test signal is a loopback-test response signal returned from the egress node.

Then, the GMPLS controller 19 checks the normality of the returned loopback-test response signal. The GMPLS controller 19 determines whether or not the response information in the J1-byte of the path overhead is normal and the payload contains data for the loopback-test signal. When it is determined that the response information in the J1-byte of the path overhead is normal and the payload contains data for the loopback-test signal, the GMPLS controller 19 determines that the loopback-test on the egress node has normally ended.

When the response information in the J1-byte of the path overhead is different from an expected value or the payload does not contain data for the loopback-test signal, the GMPLS controller 19 determines that the loopback-test on the egress node has failed. After that, the GMPLS controller 19, for example, goes into path cancellation processing.

When receiving the instruction to cancel the alarm inhibition from the control terminal 40, the GMPLS controller 19 transmits “Path MSG” on the basis of the RSVP protocol to the relay node 20. When receiving “Resv MSG”, the GMPLS controller 19 notifies the alarm controller 17 of the instruction to cancel the alarm inhibition. After that, the GMPLS controller 19 transmits the notification that the control over the alarm inhibition has completed to the control terminal 40. Then, the path establishment process completes.

When the response in the J1-byte of the path overhead of the received test signal returned from the egress node 30 is different from an expected value or the payload does not contain data for the loopback-test for some reason, the GMPLS controller 19 performs loopback-test failure processing. When the response is not returned within a specified period of time, the GMPLS controller 19 causes the ingress node to detect the timeout and retries loopback-test processing.

FIG. 6 is a diagram illustrating an example of a configuration of a GMLS controller, according to an embodiment. The GMPLS controller 19 includes a path setting part 19i for setting a communication path on the basis of a specified protocol. The GMPLS controller 19 further includes, as parts for performing a loopback-test, a loopback-test acceptor 19a, a loopback-test requesting part 19b, a loopback-test response analyzer 19c, a loopback-test error processing part 19d, a loopback-test normal processing part 19e, a loopback-test node selector 19f, a test signal creating part 19g, and a test signal transmitting part 19h. These components will be described with reference to FIG. 6.

After the path setting process has completed, the loopback-test acceptor 19a notifies the loopback-test requesting part 19b of the instruction to start loopback-test processing. The loopback-test requesting part 19b requests the corresponding parts (such as the OH inserter 12, payload inserter 14, and output interface 18) to execute a loopback-test.

The loopback-test response analyzer 19c is a processing part that performs processing on the basis of the result of a loopback-test. More specifically, the loopback-test response analyzer 19c receives the loopback-test response signal returned from the egress node 30 and analyzes the loopback-test response signal to determine whether or not the loopback-test has completed normally on the egress node 30. When the loopback-test response analyzer 19c determines that the loopback-test on the egress node 30 has normally completed, the loopback-test response analyzer 19c causes the loopback-test normal processing part 19e to perform processing. When the loopback-test response analyzer 19c determines that the loopback-test has abnormally ended, the loopback-test response analyzer 19c causes the loopback error processing part 19d to perform processing.

When a loopback-test on the egress node 30 has abnormally ended, the loopback-test error processing part 19d performs the retry loopback-test processing. More specifically, the loopback-test error processing part 19d records error information in the management information DB 10A, for example, as depicted in FIG. 7.

Then, the loopback-test error processing part 19d determines whether or not the loopback-test is to be retried. When the loopback-test is to be retried, the loopback-test error processing part 19d determines whether or not the loopback-test has been executed on all the nodes positioned along the communication path. When it is determined that the loopback-test has not been executed on all the nodes, the loopback-test node selector 19f selects a target node on which the loopback-test is to be performed on the basis of the management information DB 10A, and performs the loopback-test processing again.

When it is determined that the loopback is not to be retried and the loopback has been executed on all the nodes positioned along the communication path, the loopback failure processing part 19d notifies the control terminal 40 of the notification that the loopback-test will fail, and ends the processing.

The loopback-test normal processing part 19e notifies the control terminal 40 of the notification that the loopback-test has normally ended, and proceeds to alarm inhibition cancelling processing.

When the loopback-test node selector 19f is requested to execute a loopback by the loopback requesting part 19b, the loopback-test node selector 19f searches the management DB 10A for information on a node to which a loopback-test can be applied. Here, a node to which the loopback can be applied means a node that can return a loopback-test response signal. As to a node having undergone a loopback-test, information indicating that the loopback-test was performed on the node is stored in the management DB 10A, for example, as depicted in FIG. 7. As to the other nodes, information indicating that the loopback-test has not been executed is stored. In other words, the other nodes excluding the ingress node become nodes to which the loopback-test is applicable. Here, it is assumed that the selecting order of nodes is set beforehand.

When the received loopback-test response signal is abnormal or when the timeout is detected after a lapse of a specified time, the loopback-test node selector 19f selects a loopback-test target node to which the loopback-test signal is to be transmitted by searching the management DB 10A.

The test signal creating part 19g creates a loopback-test signal. The test signal transmitter 19h transmits the created loopback-test signal to the selected loopback-test target node.

### [Configuration of Relay Node]

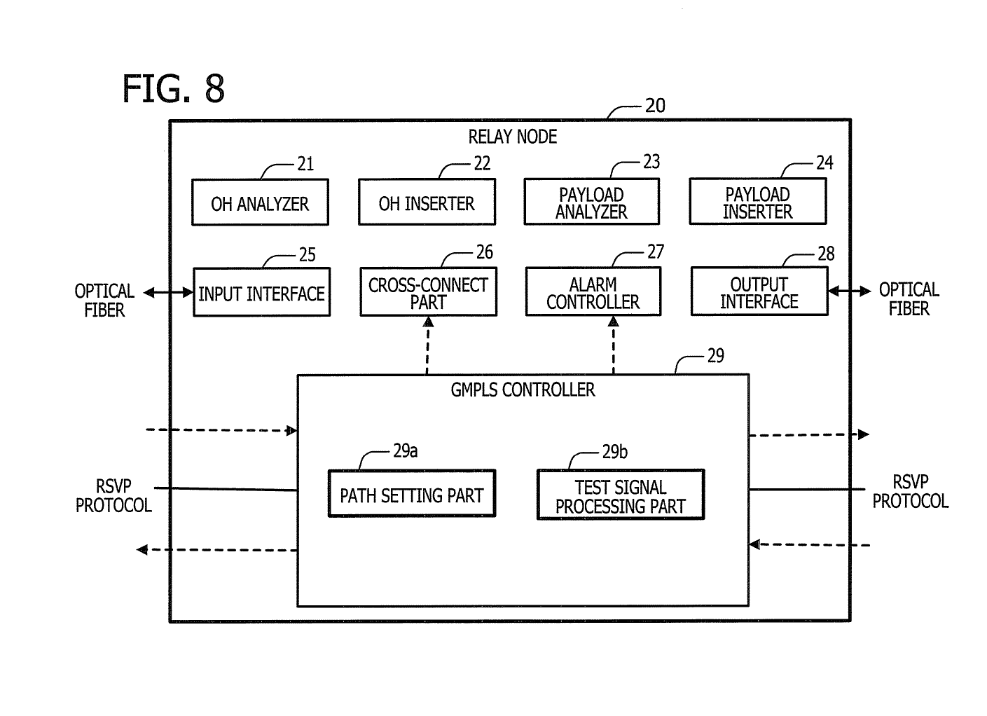

FIG. 8 is a diagram illustrating an example of a configuration of a relay node, according to an embodiment. As depicted in FIG. 8, the relay node 20 includes an OH analyzer 21, an OH inserter 22, a payload analyzer 23, a payload inserter 24, an input interface 25, a cross-connect part 26, an alarm controller 27, an output interface 28, and a GMPLS controller 29. The GMPLS controller 29 further includes a path setting part 29a and a test signal processing part 29b. The processing by these parts will be described below.

The OH analyzer 21 extracts node information from the J1-byte of the path overhead and analyzes the extracted node information. The OH inserter 22 inserts node information into the J1-byte of the path overhead. The payload analyzer 23 analyzes the payload in a SONET frame. The payload inserter 24 creates a payload for a loopback-test by inserting a test data into the payload.

The input interface 25 and output interface 28 perform data transmission and reception via an optical fiber. More specifically, the input interface 25 receives a test signal via an optical fiber and notifies the OH analyzer 21 and payload analyzer 23 of the received test signal. The output interface 28 transmits a test signal via an optical fiber. The input interface 25 and output interface 28 are connected with each other via the cross-connect part 26.

Upon receiving the instruction to set cross-connect from the GMPLS controller 29, the cross-connect portion 26 connects between the input interface 25 and the output interface 28.

Upon receiving the instruction to inhibit alarms from the GMPLS controller 29, the alarm controller 27 performs the alarm inhibition setting processing. Upon receiving the instruction to cancel alarm inhibition from the GMPLS controller 29, the alarm controller 27 performs the alarm inhibition cancelling processing.

When receiving “Path MSG” from the ingress node 10, the path setting part 29a of the GMPLS controller 29 notifies the alarm controller 27 of the instruction to set alarm inhibition. Then, the path setting part 29a of the GMPLS controller 29 transmits “Path MSG” to the neighboring relay node 20 or the egress node 30 in the downstream direction (or in the direction of the egress node 30) on the basis of the RSVP protocol.

After that, when receiving “Resv MSG” from the egress node 30, the path setting part 29a of the GMPLS controller 29 notifies the cross-connect part 26 of the instruction to set cross-connect. Then, the path setting part 29a of the GMPLS controller 29 transmits “Resv MSG” to the neighboring relay node 20 or the ingress node 10 in the upstream direction (or in the direction of the ingress node 10) on the basis of the RSVP protocol.

Upon receiving the analysis result on the J1-byte from the OH analyzer 21, the test signal processing part 29b of the GMPLS controller 29 determines whether or not the received test signal is destined for the own node on the basis of the Node ID and Link ID of the egress node 30 which are inserted into the J1-byte of the received test signal. When the received test signal is not destined for the own node, the test signal processing part 29b of the GMPLS controller 29 instructs the output interface 28 to transmit the received test signal to the neighboring relay node 20 or the egress node 30 in the downstream direction since the own node is not an egress node on which a loopback-test is to be performed and a loopback-test response signal is not needed to be returned in response to the received test signal.

Upon receiving the analysis result on the J1-byte from the OH analyzer 21, the GMPLS controller 29 determines whether or not the received test signal is a test response signal that is destined for the own node on which a loopback-test is to be performed, on the basis of the Node ID and Link ID of the egress node 30 that are inserted into the J1-byte of the received test signal.

When the GMPLS controller 29 determines that the received test signal is not destined for the own node, the test signal processing part 29b of the GMPLS controller 29 instructs the output interface 28 to transmit the received test signal to the neighboring relay node 20. In the case, the test signal processing part 29b of the GMPLS controller 29 transfers the received test signal to the neighboring node 20 or the egress node 30 in the downstream direction when the received test signal is a loopback-test signal, and transfers the received test signal to the neighboring node 20 or the ingress node 10 in the upstream direction when the received test signal is a loopback-test response signal which is indicated by the J1-byte.

Upon receiving “Path MSG”, the path setting part 29a of the GMPLS controller 29 transmits “Path MSG” to the neighboring relay node 20 or the egress node 30 in the downstream direction on the basis of a specified path setting protocol, for example, the RSVP protocol. Upon receiving “Resv MSG”, the path setting part 29a of the GMPLS controller 29 notifies the alarm controller 27 of the instruction to cancel the alarm inhibition. Then, the path setting part 29a of the GMPLS controller 29 transmits “Resv MSG” to the neighboring relay node 20 or the ingress node 10 in the upstream direction.

### [Configuration of Egress Node]

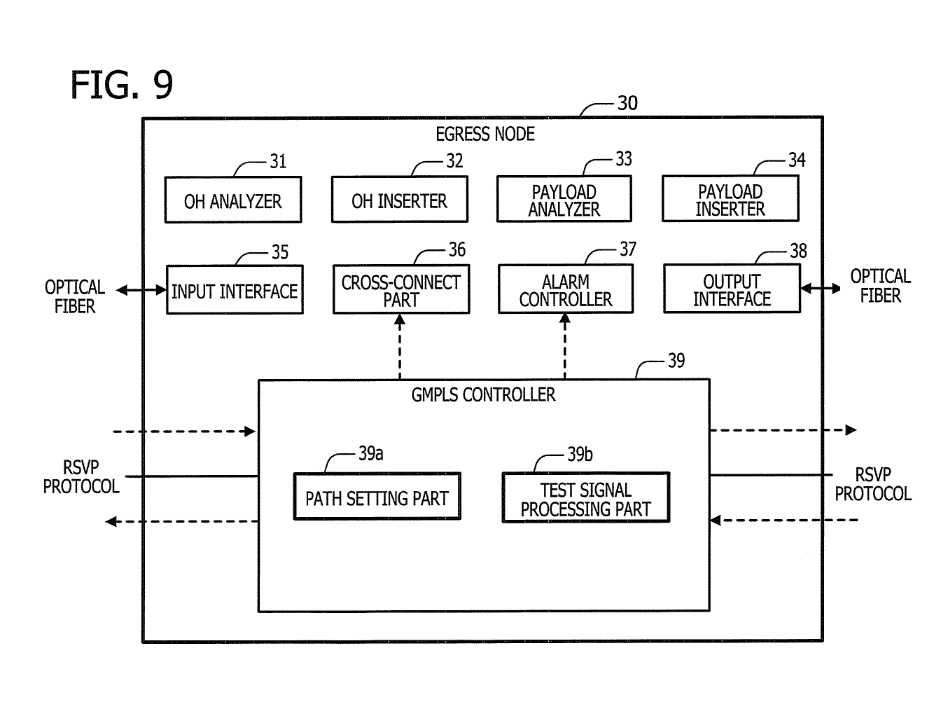

FIG. 9 is a diagram illustrating an example of a configuration of an egress node, according to an embodiment. As depicted in FIG. 9, the egress node 30 includes an OH analyzer 31, an OH inserter 32, a payload analyzer 33, a payload inserter 34, an input interface 35, a cross-connect part 36, an alarm controller 37, an output interface 38 and a GMPLS controller 39. The GMPLS controller 39 further includes a path setting part 39a and a test signal processing part 39b. The processing by these parts will be described below.

The OH analyzer 31 extracts node information (Node ID and Link ID of the ingress and Node ID and Link ID of the egress node) contained in the J1-byte of the path overhead, and analyzes the extracted node information. Then, the OH analyzer 31 notifies the GMPLS controller 39 of the analysis result on the J1-byte.

Upon receiving the instruction to create a J1-byte for a loopback-test response signal from the GMPLS controller 39, the OH inserter 32 creates a J1-byte for a loopback-test response signal by setting the result of the loopback-test to the J1-byte.

The payload analyzer 33 analyzes the payload in a SONET frame. Upon receiving the instruction to create a payload from the GMPLS controller 39, the payload inserter 34 creates a payload for a loopback-test response signal and notifies the output interface 38 of the created payload so as to transmit the loopback-test response signal to the relay node 20 in the upstream direction.

The input interface 35 and output interface 38 perform data transmission and reception via an optical fiber. More specifically, the input interface 35 receives a test signal via an optical fiber from the relay node 20 in the upstream direction, and the output interface 38 transmits a test signal via an optical fiber to the relay node 20 in the upstream direction. The input interface 35 and output interface 38 are connected with each other via the cross-connect part 36.

The input interface 35 and output interface 38 perform data transmission and reception via an optical fiber. More specifically, the input interface 35 receives a test signal via an optical fiber and notifies the OH analyzer 31 and payload analyzer 33 of the received test signal. The output interface 38 transmits the test signal via an optical fiber. The input interface 35 and output interface 38 are connected with each other via the cross-connect part 36.

When receiving the instruction to set cross-connect from the GMPLS controller 39, the cross-connect part 36 connects between the input interface 35 and the output interface 38.

When receiving the instruction to inhibit alarms from the GMPLS controller 39, the alarm controller 37 performs the alarm inhibition setting. When receiving the instruction to cancel alarm inhibition from the GMPLS controller 39, the alarm controller 37 performs the alarm inhibition cancelling processing.

Upon receiving “Path MSG” from the relay node 20, the path setting part 39a of the GMPLS controller 39 notifies the alarm controller 37 of the instruction to set alarm inhibition. Then, the path setting part 39a of the GMPLS controller 39 notifies the cross-connect part 36 of the instruction to set cross-connect. After that, the path setting part 39a of the GMPLS controller 39 transmits “Resv MSG” to the relay node 20 on the basis of the RSVP protocol.

Upon receiving the analysis result on the J1-byte from the OH analyzer 31, the GMPLS controller 39 determines whether or not the received test signal is destined for the own node on the basis of the Node ID and Link ID of the egress node 30 which are inserted in the J1-byte of the received test signal. When the GMPLS controller 39 determines that the received test signal is destined for the own node, the own node is a loopback-test target node on which a loopback-test is to be performed, for example, the egress node. Then the test signal processing part 39b of the GMPLS controller 39 notifies the OH inserter 32 of the instruction to create a J1-byte for a loopback-test response signal, and further notifies the payload inserter 34 of the instruction to create a payload for the loopback-test response signal, so as to transmit the loopback-test response signal including the created J1-byte and the created payload to the relay node 20 in the upstream direction.

Upon receiving “Path MSG”, the path setting part 39a of the GMPLS controller 39 notifies the alarm controller 37 of the instruction to cancel the alarm inhibition. Then, the path setting part 39a of the GMPLS controller 39 transmits “Resv MSG” to the relay node 20 on the basis of the RSVP protocol.

### [Processing by Loopback Test System]

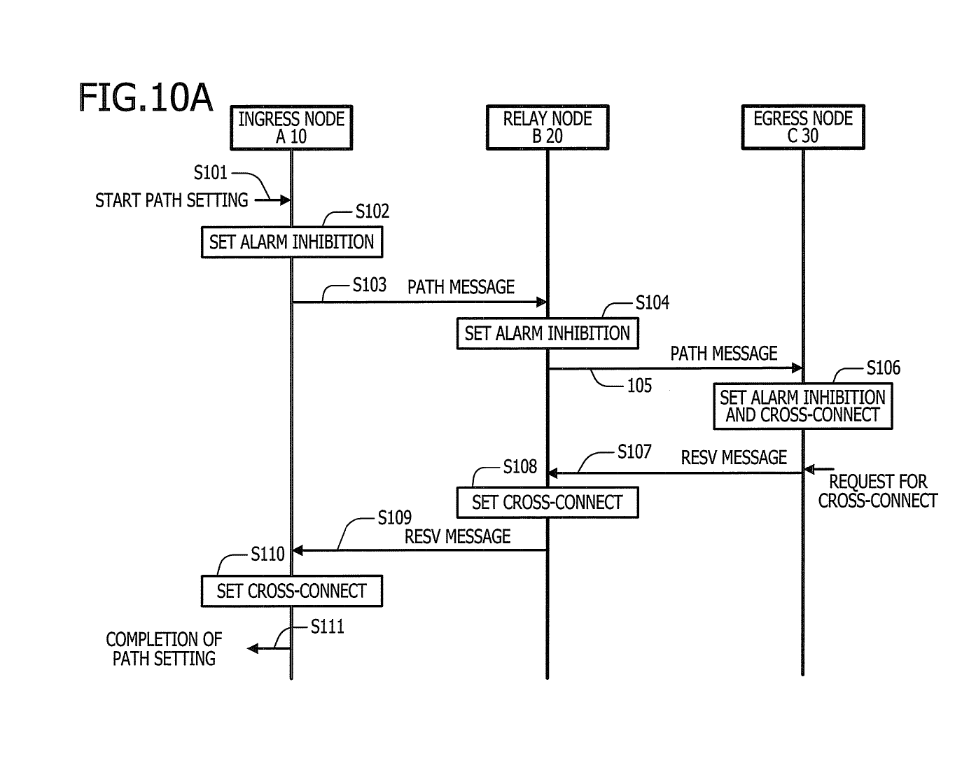

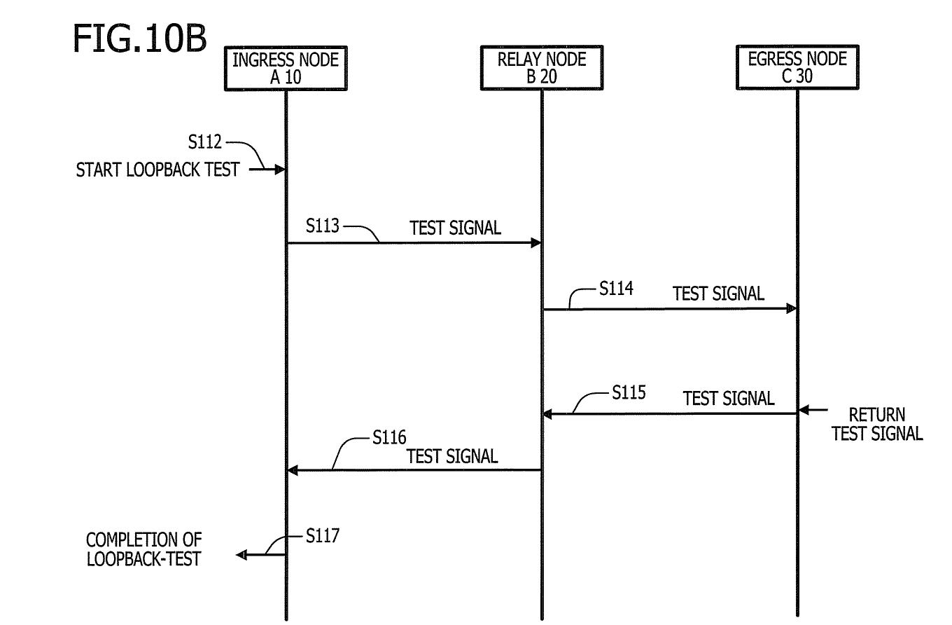

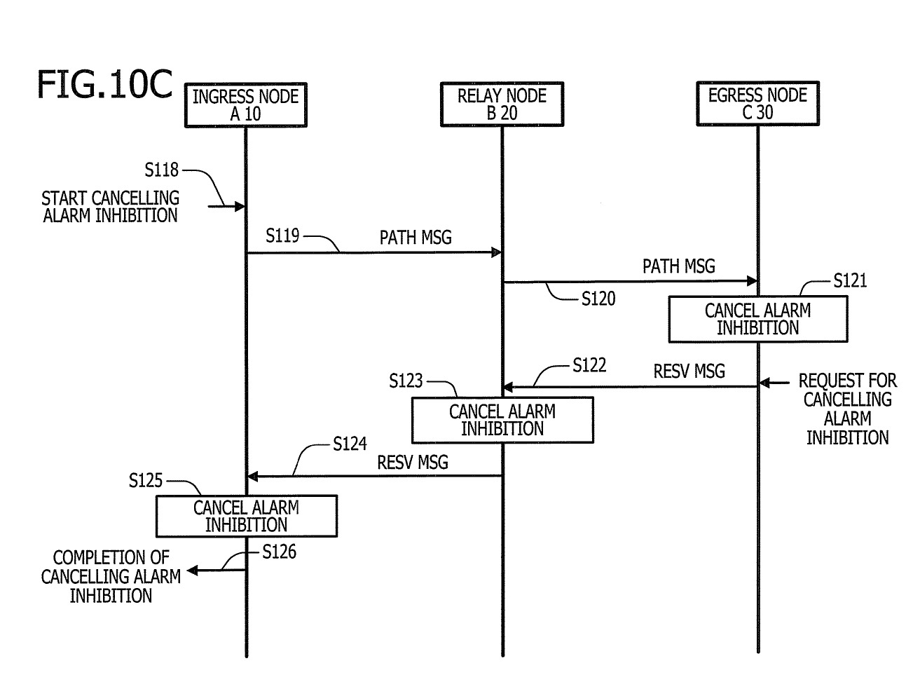

FIGS. 10A, 10B, and 10C are a diagram illustrating an example of a sequence flow for setting a communication path and performing a loopback-test, according to an embodiment. As depicted in FIG. 10A, upon receiving receives a request to start path control from the control terminal 40 (in step S101), the ingress node A 10 in the loopback test system sets the alarm inhibition (in step S102), and then transmits “Path MSG” to the relay node B 20 (in step S103).

Then, upon receiving “Path MSG”, the relay node B 20 sets the alarm inhibition (in step S104) and transmits “Path MSG” to the egress node 30 (in step S105). Next, upon receiving “Path MSG”, the egress node C 30 sets the alarm inhibition and sets the cross-connect (in step S106).

Then, the egress node C 30 transmits “Resv MSG” to the relay node B 20 (in step S107). Upon receiving “Resv MSG”, the relay node B 20 set the cross-connect (in step S108) and transmits “Resv MSG” to the ingress node A 10 (in step S109).

Upon receiving “Resv MSG”, the ingress node 10 set the cross-connect (in step S110), and notifies the control terminal 40 of the completion of the path setting (in step S111). Then, as depicted in FIG. 10B, when the ingress node 10 receives the instruction to start a loopback-test from the control terminal 40 (step S112), the ingress node A 10 sets node information to the J1-byte, inserts data for a loopback-test into the payload, and transmits the loopback-test signal to the relay node 20 (in step S113).

After that, upon receiving the loopback-test signal, the relay node B 20 transmits the loopback-test signal to the egress node C 30 when the node information set in the J1-byte of the path overhead is not destined for the own node (in step S114).

Upon receiving the loopback-test signal, the egress node C 30 sets “normal” to the response in the J1-byte when the node information set in the J1-byte of the path overhead is destined for the egress node 30. Then, the egress node C 30 copies the received payload to a loopback-test response signal which is to be returned to the ingress node A 10, and transmits the loopback-test response signal to the ingress node A 10 through the relay node B 20 (in step S115).

Upon receiving the loopback-test response signal, the relay node B 20 transmits the test signal to the ingress node A 10 when the node information in the J1-byte of the path overhead is not destined to the own node (in step S116). Then, upon receiving the test signal, the ingress node A 10 determines that the loopback-test on the egress node C 30 has normally ended when the response in the J1-byte of the path overhead is “normal” and the payload contains data for the loopback-test, and notifies the control terminal 40 of the determination (in step S117).

After that, when receiving the request to start cancelling the alarm inhibition from the control terminal 40 (in step S118), the ingress node A 10 transmits “Path MSG” to the relay node B 20 (in step S119). Next, when receiving the “Path MSG”, the relay node B 20 transmits the “Path MSG” to the egress node C 30 (in step S120).

Further, when receiving the “Path MSG”, the egress node C 30 cancels the alarm inhibition (in step S121) and transmits “Resv MSG” to the relay node B 20 (in step S122). Then, when receiving the “Resv MSG”, the relay node C 20 cancels the alarm inhibition (in step S123) and transmits the “Resv MSG” to the ingress node A 10 (in step S124).

After that, when receiving the “Resv MSG”, the ingress node A 10 cancels the alarm inhibition (in step S125), and transmits information indicating completion of the control over the alarm inhibition to the control terminal 40 (in step S126).

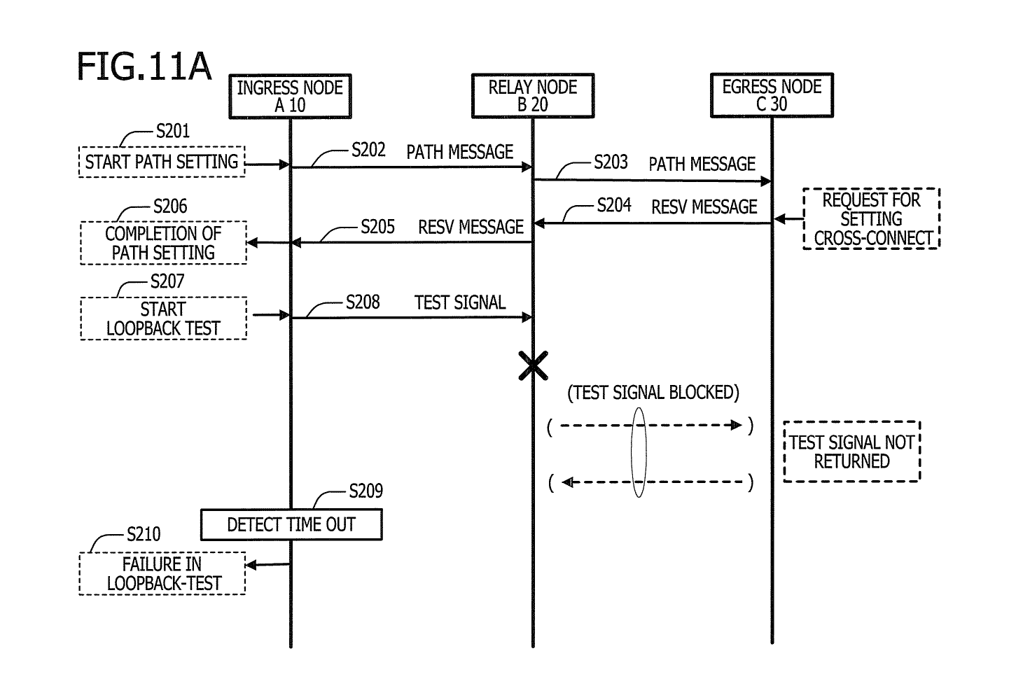

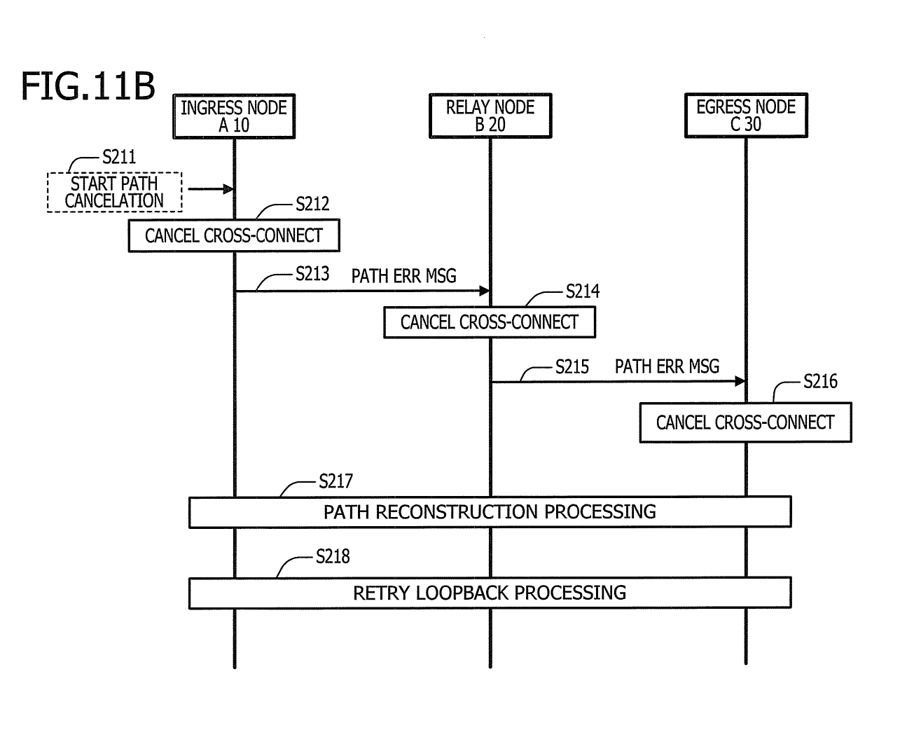

FIGS. 11A and 11B are a diagram illustrating an example of a sequence flow of retry loopback test processing, according to an embodiment. With reference to FIGS. 11A and 11B, the retry loopback test processing to be performed when an abnormality occurs during the loopback test processing will be described. As depicted in FIG. 11A, after performing the path setting processing (in steps S201 to S206), upon receiving the instruction to start a loopback-test from the control terminal 40 (in step S207), the ingress node A 10 transmits a test signal to the relay node B 20 by setting node information to the J1-byte and inserting data for a loopback-test into the payload (in step S208).

Here, when the relay node B 20 receives the loopback-test signal from the ingress node A 10 and transmits the loopback-test signal to the egress node C 30, the path might be disconnected for some reason, such as a line fault, as depicted in FIG. 11A. In this case, the loopback-test signal might not be transmitted to the egress node C 30 and might be discarded. If the response of the loopback-test is not returned to the ingress node A 10 within a specified period of time, the ingress node A 10 detects the response timeout (in step S209). Then, the ingress node A 10 notifies the control terminal 40 that the loopback-test on the egress node C 30 has failed (in step S210).

After that, as depicted in FIG. 11B, when the ingress node A 10 receives a request to start path cancelling from the control terminal 40 (in step S211), the ingress node 10 cancels the cross-connect (in step S212) and transmits “PathErr MSG” to the relay node 20 (in step S213).

When receiving the “PathErr MSG”, the relay node B 20 cancels the cross-connect (in step S214) and transmits the “PathErr MSG” to the egress node C 30 (in step S215). After that, when receiving the “PathErr MSG”, the egress node C 30 cancels the cross-connect (in step S216).

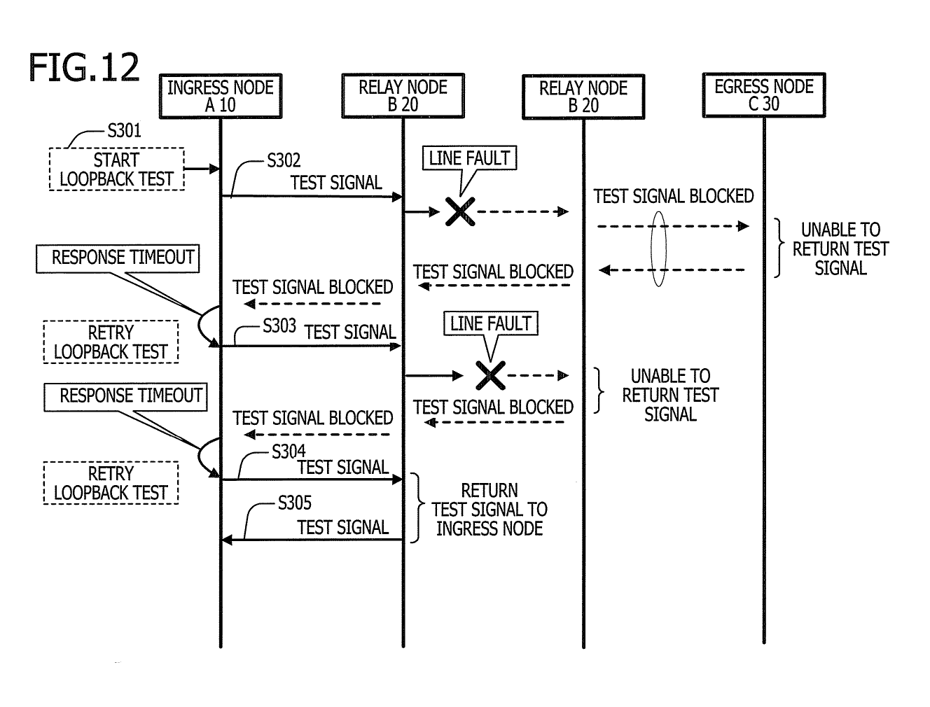

After finishing the path cancelling processing, the ingress node A 10 again performs the path setting processing in the same way described in step S101 to S111 of FIG. 10, as path reconstruction processing (in step S217). After that, the ingress node A 10 performs retry loopback processing (which will be described later in detail with reference to FIG. 12) (in step S218).

FIG. 12 is a diagram illustrating an example of a sequence flow of retry loopback test processing, according to an embodiment. FIG. 12 illustrates an example in which a signal may not be communicated between the relay node B 20 and the relay node C 20 for some reason. As depicted in FIG. 12, when the ingress node 10 receives the instruction to start a loopback-test from the control terminal 40 (in step S301), the ingress node A 10 transmits a loopback-test signal to the relay node B 20 by setting node information to the J1-byte and inserting data for the loopback-test into the payload (in step S302).

Here, when the relay node B 20 transmits the loopback-test signal to the egress node D 20 after receiving the test signal from the ingress node A 10, if the path is disconnected for some reason (for example, as depicted in FIG. 12), the loopback-test signal may not be communicated to the egress node D 30 and the loopback-test response signal may not be returned from the egress node D 30.

When a loopback-test response signal is not returned to the ingress node A 10 within a specified period of time, the ingress node A 10 detects the response timeout, meaning that the loopback-test from the ingress node A 10 to the egress node D 30 has failed. Next, the ingress node A 10 starts the second loopback-test by considering the relay node C 20 as a loopback-test target node that returns the loopback-test response signal.

Then, the ingress node A 10 again transmits the loopback-test signal to the relay node B 20 (in step S303). Here, since the loopback-test signal is not transmitted to the relay node 20 C due to the line fault, the ingress node A 10 detects the response timeout, meaning that the loopback-test from the ingress node A 10 to the relay node C 20 has failed, in a manner similar to the step S302.

Next, the ingress node A 10 starts the third loopback-test by considering the relay node B 20 as a loopback-test target node that returns the loopback-test response signal. The ingress node A 10 again transmits the loopback-test signal to the relay node B 20 (in step S304). In the case, the loopback-test response signal is returned normally from the relay node B 20, meaning that the loopback-test from the ingress node A 10 to the relay node B 20 has complete normally (in step S305).

In other words, from this result, it may be determined that a line fault is occurring between the relay node B 20 and the relay node C 20 since the first and second loopbacks have failed. Thus, the section having a line fault can be notified to a maintenance person.

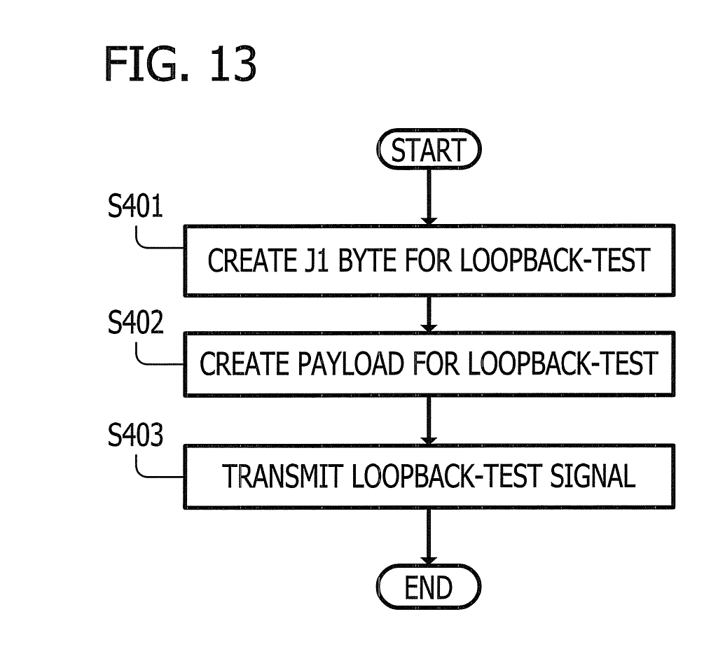

FIG. 13 is a diagram illustrating an example of an operational flowchart for transmitting a loopback-test signal executed by an ingress node, according to an embodiment. As depicted in FIG. 13, when the ingress node 10 starts loopback-test processing, the ingress node 10 creates the J1-byte for a loopback-test by inserting information for a loopback-test (information on the ingress node and the egress node) into a J1-byte of the path overhead (in step S401).

Then, the ingress node 10 creates a payload for the loopback-test by inserting the information for the loopback into the payload (in step S402). After that, the ingress node 10 transmits a loopback-test signal storing the created J1-byte and the created payload to the relay node 20 (in step S403).

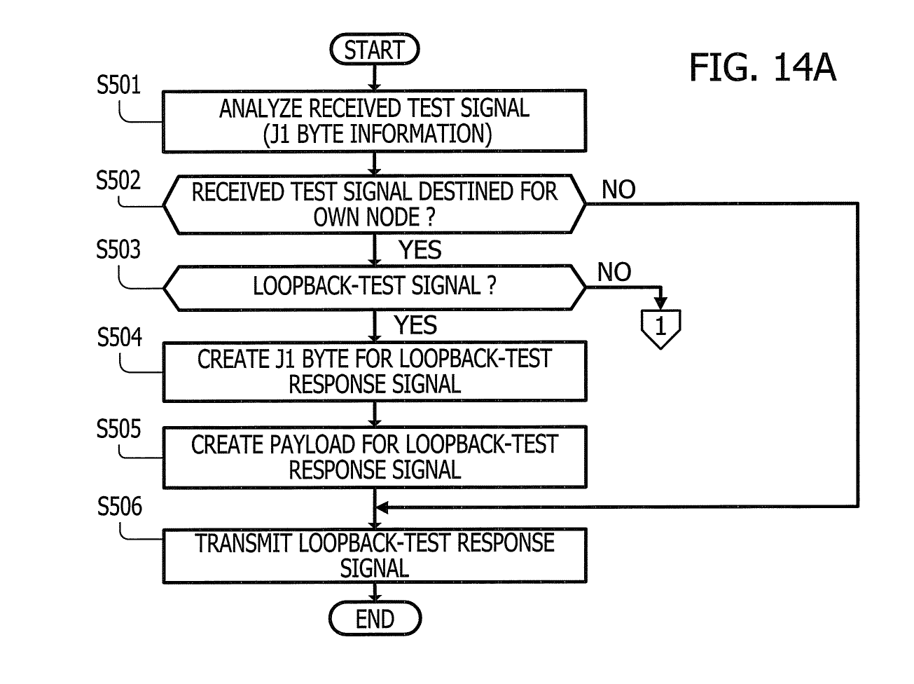

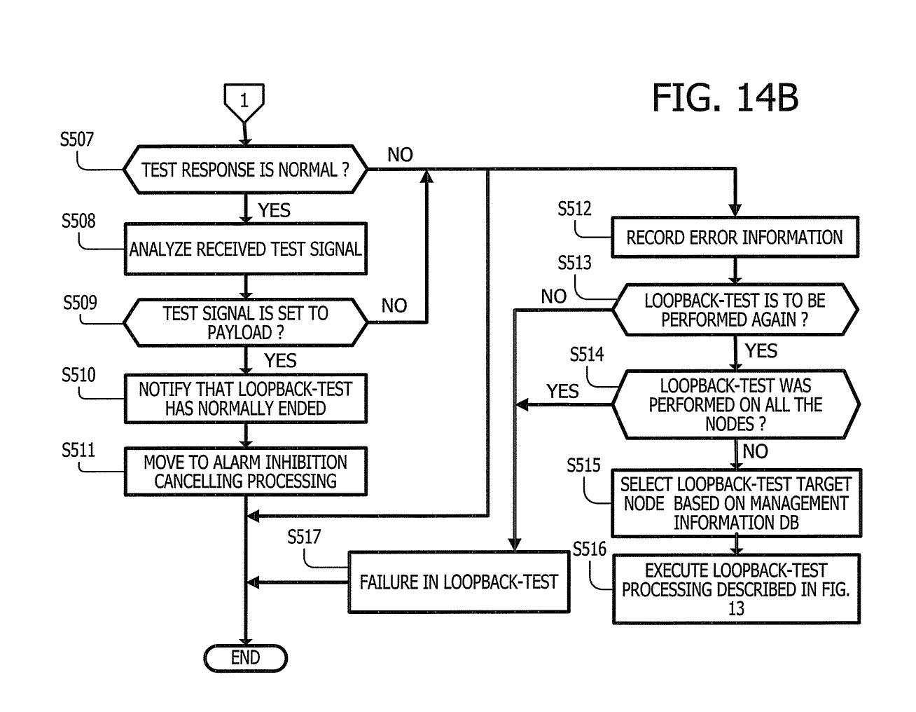

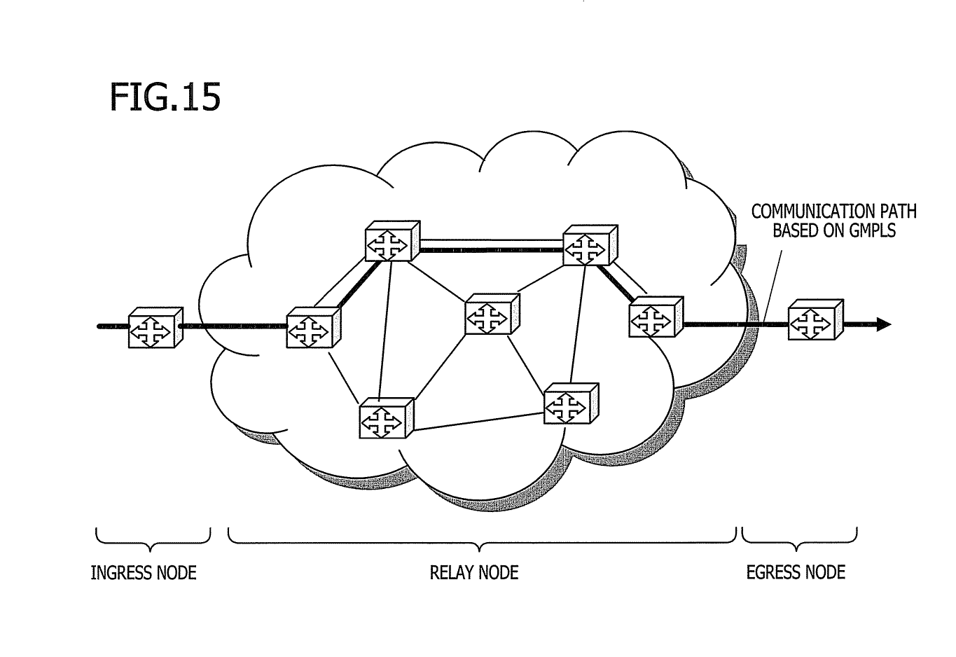

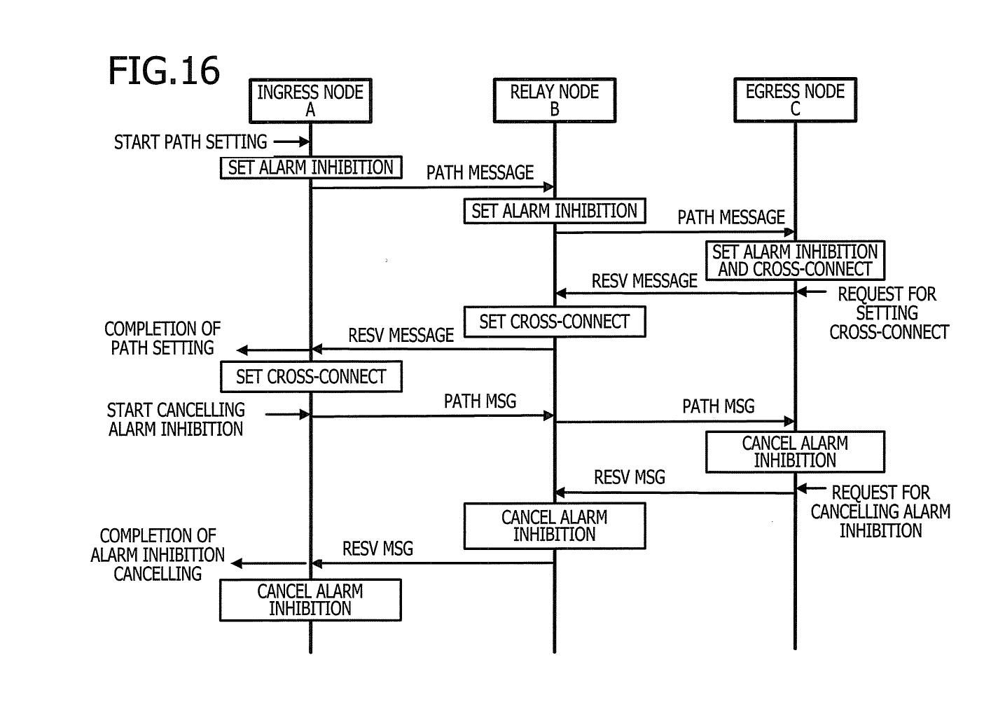

FIG. 14A, 14B, and 14C are a diagram illustrating an example of an operational flowchart of a node for performing a loopback-test, according to an embodiment. With reference to FIG. 14, processing operations by the node when performing a loopback-test will be described. The processing described below with reference to FIG. 14 is processing applicable to all of an ingress node 10, a relay node 20, and an egress node 30. The ingress node 10, relay node 20, and egress node 30 will collectively be called a communication node, hereinafter.

When receiving a test signal, the communication node analyzes the received test signal (J1-byte information) (in step S501) and determines whether the received test signal is a test signal destined for the own node or not (in step S502). When it is determined that the received test signal is not a test signal destined for the own node (NO in step S502), the communication node transfers the received test signal to the neighboring communication node (in step S506).

When it is determined that the received test signal is a test signal destined for the own node (YES in step S502), the communication node further determines whether or not the received test signal is a loopback-test signal that is not returned from the egress node (in steps 503). When it is determined that the received test signal is a loopback-test signal (YES in step S503), the communication node determines that the received loopback-test signal is destined for the own node (that is, the own node becomes a loopback-test target that returns a loopback-test response signal) and create a J1-byte for a loopback-test response signal by setting the response for the loopback-test to the J1-byte (in step S504).

Then, the communication node creates a payload for the loopback-test response signal by setting data for the loopback-test to the payload (in step S505). After that, the communication node transmits the loopback-test response signal including the created J1-byte and payload to the source communication node (or the ingress node) (in step S506).

Referring back to step S503, when the received test signal is not a loopback-test signal (NO in step S503), the communication node determines that the received test signal is a loopback-test response signal that was returned to the own node (or the own node is the ingress node) and determines whether or not the test response set in the J1-byte is normal (in step S507).

When the communication node determines that the test response set in the J1-byte is normal (YES in step S507), the communication node analyzes the payload of the received test signal (in step S508) and determines whether or not the payload includes information on the setting of a loopback-test signal (in step S509).

When the communication node determines that the payload includes information on the setting of a loopback-test signal (YES in step S509), the communication node notifies that the loopback has normally ended to the control terminal 40 (in step S510) and moves to the alarm inhibition cancelling processing (in step S511).

When the communication node determines that the test response set in the J1-byte is not normal (NO in step S507) or the payload does not include information on the setting of a loopback-test signal (NO in step S509), the communication node records the error information in the management information DB 10A as the retry loopback processing (in step S512).

Then, the communication node determines whether or not a loopback-test is to be performed again (in step S513). When a loopback-test is to be performed again (YES in step S513), the communication node determines whether or not a loopback-test is performed on all the nodes positioned along the communication path (in step S514). When the communication node determines that a loopback-test is not performed on all the nodes (NO in step S514), the communication node selects a loopback-test target node on which the loopback-test is to be performed on the basis of the management information DB (in step S515).

After that, the communication node performs the loopback-test processing of FIG. 13 (in step S516). When the communication node determines that the loopback-test is not to be performed again (NO in step S513) and when a loopback was performed on all the nodes (YES in step S514), the communication node notifies the control terminal 40 that the loopback-test will end in failure (in step S517), and terminates the processing.

As described above, the ingress node 10 sets a communication path on the basis of a specified path setting protocol, and transmits a loopback-test signal to the egress node 30 through the communication path after completion of the setting of the communication path. Then, the ingress node 10 receives the loopback-test response signal returned by the egress node 30, and determines whether or not the loopback-test response signal is normal by analyzing the received loopback-test response signal. Thus, the ingress node 10 can easily perform a loopback-test by utilizing the information used in the path setting based on GMPLS, thereby guaranteeing the normal signal communication through the established communication path. A loopback-test may be performed automatically by incorporating it into the procedure for setting a communication path based on GMPLS. Therefore, the signal communication level can be checked without regard to the automatically created path configuration.

According to the first embodiment, the ingress node 10 transmits a loopback-test signal to the egress node 30 by setting a test signal type to the J1-byte which is configured to be set arbitrarily by a user. Thus, an existing path overhead based on GMPLS may be used for a loopback-test.

According to the first embodiment, when the ingress node 10 determines that the loopback-test response signal is abnormal by analyzing the loopback-test response signal, the ingress node 10 changes a loopback-test target node on which a loopback-test is to be performed and transmits the test signal to the changed loopback-test target node. Thus, the section having a line fault can be identified.

According to the first embodiment, after a lapse of a specified period of time after a test signal is transmitted, the ingress node 10 changes the destination node of the test signal and transmits the test signal to the changed destination node. Thus, the section having a line fault may be identified.

### Second Embodiment

The present invention may be implemented in various different forms in addition to the above mentioned embodiment. A second embodiment including other embodiments will be described below.

### (1) System Configuration and Others

The components of the apparatus are described as exemplary examples, and their configurations are not limited to them. In other words, the concrete forms of the distribution and integration of the apparatus are not limited to the ones depicted in the above embodiment. All or a part of them may be configured by functionally or physically distributing and integrating them in arbitrary units in accordance with the corresponding loads and the usages. For example, the OH analyzer 11 and the OH inserter 12 may be integrated. All or an arbitrary part of the processing functions to be implemented in the apparatus, may be implemented by a CPU and a program executed by the CPU, or may be implemented by a wired logic.

All or a part of the processing described to be performed automatically may be performed manually, or all or a part of the processing described to be performed manually may be performed automatically by a known method. In addition, processing sequences, control sequences, specific names, information including various types of data and parameters, which are described in the document or illustrated in the drawings, may be changed arbitrarily if not otherwise specified.

### (2) Programs

Notably, the loopback-test method according to the embodiments may be implemented by executing a prepared program by a computer such as a personal computer and a workstation. The program may be distributed over a network such as the Internet. The program may further be recorded in a computer-readable recording medium such as a hard disk, a flexible disk (FD), a CD-ROM, an MO, and a DVD, and be read from the recording medium by a computer to execute.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A node apparatus operable to perform a loopback-test on a communication path in a network, comprising:
a path setting part operable to set a communication path from an ingress node to an egress node on the basis of a specified path setting protocol;
a test signal transmitter operable to transmit a loopback-test signal to the egress node through the communication path set by the path setting part, so as to perform a loopback-test on the egress node; and
a loopback-test response analyzer operable to receive a loopback-test response signal returned from the egress node on which the loopback-test has been performed, and determining whether or not the loopback-test on the egress node has ended normally by analyzing the received loopback-test response signal.

2. The node apparatus of claim 1, further comprising:
a loopback-test node selector operable to select a loopback-test target node on which a loopback-test is to be performed, from nodes that are positioned along the communication path and have not undergone a loopback-test, when the loopback-test on the egress node has abnormally ended,
wherein the test signal transmitter transmits a loopback-test signal to the loopback-test target node selected by the loopback-test node selector so as to perform a loopback-test on the selected loopback-test target node.

3. The node apparatus of claim 1, further comprising:
a loopback-test node selector operable to select a loopback-test target node on which a loopback-test is to be performed, from nodes that are positioned along the communication path and have not undergone a loopback-test, when a specified time elapsed without receiving the loopback-test response signal from the egress node, after the test signal was transmitted to the egress node,
wherein the test signal transmitter transmits a loopback-test signal to the loopback-test target node selected by the loopback-test node selector so as to perform a loopback-test on the selected loopback-test target node.

4. The node apparatus of claim 1, wherein
the test signal transmitter transmits the loopback-test signal by setting information identifying the loopback-test signal to an area which is not used by the specified path setting protocol.

5. A node apparatus, comprising:
a path setting part operable to set a communication path from an ingress node to an egress node on the basis of a specified path setting protocol;
a test signal processing part operable to receive a test signal and processing the received test signal, the test signal including one of a loopback-test signal and a loopback-test response signal, the loopback-test signal being a test signal for performing a loopback-test on a node positioned along the communication path, the loopback-test response signal being a test signal for conveying a result of the loopback-test performed on the node, wherein
the test signal processing part transfers the received test signal to an adjacent node positioned along the communication path when the received test signal is not destined for the node apparatus, and
transmits the loopback-test response signal to the ingress node that has transmitted the loopback-test signal, in response to the received loopback-test signal, when the received loopback-test signal is destined for the node apparatus.

6. A method for performing a loopback-test on a communication path in a network, comprising:
setting a communication path from an ingress node to an egress node on the basis of a specified path setting protocol;
transmitting a loopback-test signal to the egress node through the communication path so as to perform a loopback-test on the egress node;
receiving a loopback-test response signal returned from the egress node on which the loopback-test has been performed; and
determining whether or not the loopback-test on the egress node has ended normally by analyzing the received loopback-test response signal.

7. The method of claim 6, further comprising:
selecting a loopback-test target node on which a loopback-test is to be performed, from nodes that are positioned along the communication path and have not undergone a loopback-test yet, when the loopback-test on the egress node has abnormally ended,
wherein a loopback-test signal is transmitted to the selected loopback-test target node so as to perform a loopback-test on the selected loopback-test target node.

8. The method of claim 6, further comprising:
selecting a loopback-test target node on which a loopback-test is to be performed, from nodes that are positioned along the communication path and have not undergone a loopback-test, when a specified time elapsed without receiving the loopback-test response signal from the egress node, after the test signal was transmitted to the egress node,
wherein a loopback-test signal is transmitted to the selected loopback-test target node so as to perform a loopback-test on the selected loopback-test target node.
